(19) United States
(12) Patent Application Publication
(10) Pub. No.: US 2025/0244130 A1
(43) Pub. Date: Jul. 31, 2025

(54) MONITORING AND DETECTING SENSOR FAULTS IN INERTIAL MEASUREMENT SYSTEMS

(71) Applicant: MERCEDES-BENZ GROUP AG, Stuttgart (DE)

(72) Inventors: Jens KALKKUHL, Holzgerlingen (DE); Antje MUNTZINGER, Aidlingen (DE)

(21) Appl. No.: 18/856,331

(22) PCT Filed: Feb. 27, 2023
(86) PCT No.: PCT/EP2023/054841

§ 371 Date: Oct. 11, 2024

(30) Foreign Application Priority Data
Apr. 12, 2022 (DE) 10 2022 001 242.1

(51) Int. Cl. G01C 21/16; G01C 25/00

(52) U.S. Cl. CPC G01C 21/188; G01C 21/165; G01C 25/005

(57) ABSTRACT

Faults in master or slave inertial measurement units in a vehicle are identified using measurements of the master inertial measurement unit as reference values to compensate for measurements of the slave inertial measurement unit by estimating fault model parameters with respect to the master inertial measurement unit in order to recognize a fault based on, in each case, two corresponding sensor signals from the two inertial measurement units by comparison. One of the two inertial measurement units is detected as faulty whose motion estimation calculated in a respective downstream Kalman filter in an object tracking unit leads to an incorrect prediction of the calculated positions of objects in the surroundings of the vehicle.

### BACKGROUND AND SUMMARY OF THE INVENTION

Exemplary embodiments of the invention relate to a method for recognizing faults in inertial measurement units.

Inertial measurement units (IMU) are arrangements of accelerometers and gyroscopes that measure the specific forces (accelerations) and rotational speeds of objects in space. Inertial measurement units play a critical role in estimating the state of motion of vehicles. This state of motion is required in vehicle control systems, driver assistance systems, and with autonomous driving, for example, in order to be able to interpret information from environment sensors (camera, lidar, radar) correctly. The term vehicle motion observer (VMO) has become established for arrangements and methods for calculating the vehicle ego motion from the data of the inertial measurement unit in combination with an additional vehicle sensor system [5]. Such an arrangement is represented in FIG. 1. In FIG. 1, an example of the use of an inertial measurement unit 1 for motion estimation and navigation is shown according to the prior art. The inertial measurement unit 1 sends rotational speed signals from the gyroscopes and specific force signals from the accelerometers [9]. In a sensor fusion unit 2, motion variables, for example orientation angle α, velocity v, and/or position P, are calculated from these variables by integration, and are corrected using further sensors or sensor units 3, for example odometers, magnetometers, barometric altimeters, steering angles, vehicle level and/or GNSS receivers. In the following, the result of the described data fusion is to be referred to as an estimated state of motion or as motion estimation for short. At points where confusion of the motion of the vehicle with motion of objects in the surroundings of the vehicle is possible, the terms ego motion state or ego motion estimation are to be used when referring to the vehicle.

An IMU sensor is said to have a fault if the specified (and therefore predetermined by design) relationship between the physical measured variable and the output sensor signal is lost in the sensor, resulting in unspecified measurement behavior. Thus, the affected IMU sensor becomes unusable. Faults in the sensors, which propagate in the motion calculation undetected, can result in considerable faults or grossly incorrect values in the useful signals and therefore represent a safety risk in safety-relevant applications.

Vehicle control systems, driver assistance systems, and autonomous driving are applications with very high safety requirements. Therefore, faults of the IMU sensors have to be detected automatically by the system, localized and the faulty sensors have to be eliminated from the motion calculation within a time specified for the system (FTTI: fault tolerant time interval), for example by switching to a redundant sensor (backup).

In the class of IMU systems considered here, for automobile applications (automotive grade IMU), there are already elementary monitoring functions, in particular in relation to electric faults. This type of monitoring is referred to as monolateral monitoring in the following, because monitoring is based on information from only one sensor in each case. Monolateral methods have a low sensitivity and can only recognize faults of a relatively large amplitude, i.e., the monitoring thresholds are typically too high for driver assistance systems and autonomous driving. The diagnostic coverage for smaller faults, which can also represent a safety risk, is low. The diagnostic coverage can be improved significantly by introducing redundant sensor elements.

A summary of the current prior art for sensor arrangements with simple redundancy is included in [4]. A solution in this regard is represented in FIG. 2. Here, the two redundant inertial measurement units 4 (IMU A) and 5 (IMU B) are initially calibrated to each other relative to their systematic faults (bias, sensitivity, orientation faults etc.) and afterwards the sensor values correspondingly calibrated to each other are subject to a comparison. If the difference of the measured values exceeds a threshold, then there is probably a fault in the respective sensor pair. The fault can however still not be assigned to one of the two sensors because an additional reference value is necessary for this. In [4] this problem is addressed by monitoring the innovations of the respective Kalman filters for estimating the ego motion. Since the states of motion predicted with the aid of the IMU are fused with the remaining vehicle sensors (wheel speeds, steering angle) in the two Kalman filters and the vehicle sensors represent a third independent source of information, an IMU fault can be localized by evaluating the innovations (which are a weighted difference between prediction and measurement). A disadvantage of this approach is that the measured variables derived from the vehicle sensors are substantially restricted to the translational speeds, and thus the monitoring method described in [4] is not equally selective in all degrees of freedom of motion of the IMU. For example, the sensitivity in relation to faults, which result in deviations in the rotational degrees of freedom, is low. Additionally, the detection of faults with a small amplitude is restricted by the resolution of the wheel speed sensors. Especially for a fusion of the estimated ego state of motion with environmental information as occurs in object tracking, there are sometimes higher requirements for the detection of IMU faults with smaller detection thresholds and shorter fault detection times, which may not be met by the described method.

In [7] and [6] the general claim that faults of the ego motion estimation can be recognized by fusing the environment sensors is made, but the source does not contain any specific exemplary embodiments in this regard. Furthermore, the claim concentrates on those faults that generally lead to physically implausible information about the state of motion of the vehicle. Nothing is said about those faults where the state of motion is physically possible but nevertheless incorrect. Furthermore, the solution proposed there does not contain any redundancy in relation to the inertial measurement units and in relation to the ego motion calculation. Redundancy in relation to inertial sensors is, however, necessary for short fault recognition times, and high sensitivity of fault diagnosis due to small fault thresholds.

Exemplary embodiments of the invention are directed to a novel method for recognizing faults in inertial measurement units.

A method according to the invention for recognizing faults in inertial measurement units used in a vehicle for measuring angular velocities and specific forces, wherein two inertial measurement units each with multiple sensors, comprising an accelerometer and gyroscopic sensors, are used, makes use, for example, of a multi-hypothesis approach.

According to the invention, a first inertial measurement unit is used as a master inertial measurement unit, wherein a second inertial measurement unit, the performance of which can be lower than that of the first inertial measurement unit, is used as a slave inertial measurement unit, wherein measurements of the master inertial measurement unit are used as reference values to compensate for measurements of the slave inertial measurement unit by estimating fault model parameters with respect to the master inertial measurement unit in order to recognize a fault based on, in each case, two corresponding sensor signals from the two inertial measurement units by means of comparison, wherein one of the two inertial measurement units is detected as faulty whose state of motion estimated in a respective downstream Kalman filter in an object tracking unit leads to an incorrect prediction of the calculated positions of objects in the surroundings of the vehicle.

In an embodiment, a fault condition from a monitoring unit, to which sensor values of the inertial measurement units are supplied, is transmitted to the object tracking unit, so that in the event of a fault, multiple hypotheses about the state of motion can be tested, whereas in normal operation only one state of motion is used.

In an embodiment, an ego motion of the vehicle is described by a pose of the vehicle and is transmitted to the object tracking unit.

In an embodiment, from the calculated hypotheses about the pose of the vehicle and a previously calculated object position of an object or multiple previously calculated object positions of objects, a new object position of this object or the new object positions of the objects are predicted in vehicle-fixed coordinates in the object tracking unit.

In an embodiment, the object position/s, measured by an environment sensor system of the vehicle, of one or more objects is/are compared with the object positions predicted by ego motion hypotheses of the vehicle determined by means of the Kalman filter, wherein ego motion hypotheses whose associated deviation between predicted and measured object position exceeds a threshold are detected as being incorrect.

In an embodiment, in the event of a fault in one of the inertial measurement units, if the fault has been recognized by comparing with a redundant sensor of the other of the inertial measurement units and the ego motion hypothesis calculated with a faulty sensor value has been rejected as faulty, there is a switchover to the other of the inertial measurement units.

In an embodiment, the results of the monitoring of the two inertial measurement units are included in a fault detection of the object tracking unit, wherein in this case a fault is only recognized if the deviation of the predicted object position exceeds a threshold for one of the hypotheses but does not for the other, and simultaneously a fault has been recognized via the sensor comparison of an IMU fault detection unit.

In an embodiment, only one object recognized as stationary or multiple objects recognized as stationary are included in the fault detection. A fault is recognized for the hypothesis in the case of which the predicted object position changes considerably, whereas it remains locally constant for the other hypothesis.

The invention utilizes the higher sensitivity of object tracking methods in relation to faults in the ego motion estimation specifically for fault detection and thus also realizes detection of IMU faults with a very small amplitude.

Exemplary embodiments of the invention are explained in more detail in the following using the drawings.

### BRIEF DESCRIPTION OF THE DRAWING FIGURES

Here:

FIG. 1 shows a schematic view of a typical example of the use of an inertial measurement unit (IMU) for estimating the motion variables of a vehicle,

FIG. 2 shows a schematic representation of monitoring IMU channels with simple redundancy,

FIG. 3 shows a schematic view of the solution according to the invention, inclusive of the evaluation and fault recognition of the ego motion solutions within the object tracking, and

FIGS. 4A & 4B show a schematic representation for illustrating the fundamental idea of the invention in two-dimensional space.

Parts corresponding to each other are provided with the same reference numerals in all the figures.

### DETAILED DESCRIPTION

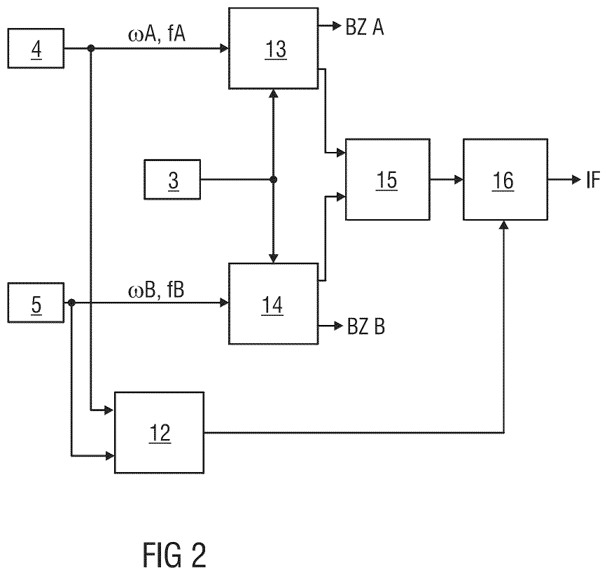

In a method for recognizing faults F in inertial measurement units with simple redundancy, two inertial measurement units 4 and 5 are used, each with several accelerometers and gyroscopic sensors, as shown in FIG. 2.

In the illustrations, the two inertial measurement units 4 and 5 are also referred to with IMU A and IMU B. Each of them provides a vector \vec{ω}_{ib}^{b} with three angular velocity signals and a vector \vec{f}_{ib}^{b} with three specific force signals. In order to simplify the representation of these signals, the superscripts and subscripts are omitted. We can then refer to the sensor signals as \vec{ω}_{A}, \vec{ω}_{B} or \vec{f}_{A}, \vec{f}_{B}.

In FIG. 2, a first inertial measurement unit 4 is used as a master inertial measurement unit, wherein a second inertial measurement unit 5 whose performance can be lower than that of the first inertial measurement unit 4, is used as a slave or backup inertial measurement unit, wherein in a monitoring unit 12, the measurements of the master inertial measurement unit 4 are used in order to estimate systematic fault parameters in models in the slave inertial measurement unit 5 relative to the master inertial measurement unit 4 and to detect signal deviations between the compensated signals, wherein too great a signal deviation can be caused by a potential fault F in one of the two inertial measurement units 4 or 5. However, the detection in the monitoring unit 12 alone does not indicate which of the two inertial measurement units 4 or 5 is affected by a fault F. However, it is possible to recognize which specific sensor pair is affected.

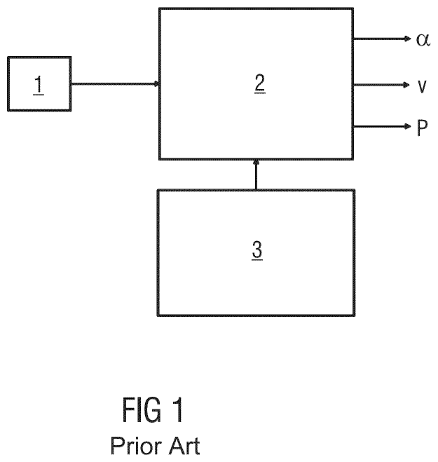

In order to calculate the state of motion of the vehicle, the angular velocity signals \vec{ω}_{A}, \vec{ω}_{B} and specific force signals \vec{f}_{A}, \vec{f}_{B} of each of the two inertial measurement units 4, 5 are each made available to a Kalman filter 13 and 14 (Vehicle motion observer, abbreviated VMO) as input variables and fused there with the measured variables of other vehicle sensors, e.g., wheel speeds and steering angles, wherein each of the two Kalman filters 13, 14 uses the same measured variables. The Kalman filters 13, 14 determine, in each case, a state of motion BZ A, BZ B for the respective inertial measurement unit 4, 5. As can be seen from FIG. 1, the described data fusion of signals of the inertial measurement unit 1 with the remaining vehicle sensor systems represents a standard method for determining the motion variables of the vehicle.

The solution proposed in [4] as prior art provides for the innovations of the two Kalman filters 13 and 14 to be monitored in a monitoring unit 15 as shown in FIG. 2 and used together with the information from the monitoring unit 12 for fault detection IF in the fault detection unit 16.

In the following description, the following formula symbols are used:
t₀ Time
u, u′ Pose of a vehicle estimated from IMU and vehicle sensor system
Δg_{eb}ⁿ Vehicle orientation angle increment
Δp_{eb}ⁿ Vehicle position increment
C(Δq_{eb}ⁿ) Rotation matrix calculated from the orientation angle increment
H(u) Homogeneous transformation of earth-fixed coordinates to vehicle-fixed coordinates
x Object position
z Object position measurement using an environment sensor system.
K Kalman filter amplification
v Innovation
S Measurement fault covariance matrix
P⁻ Condition fault covariance matrix before correction with measurement (a-priori)
R Covariance matrix of the measurement
K Threshold
Yaw angle of the vehicle in relation to an earth-fixed coordinate system
ΔΨ Yaw angle increment
ω_{z} Yaw rate
δω_{z} Yaw rate fault
vₓ Vehicle longitudinal speed
v_{y} Vehicle transverse speed
Δt Time interval between two measurements
lᵣ Distance of vehicle-fixed coordinate system from the rear axle of the vehicle.

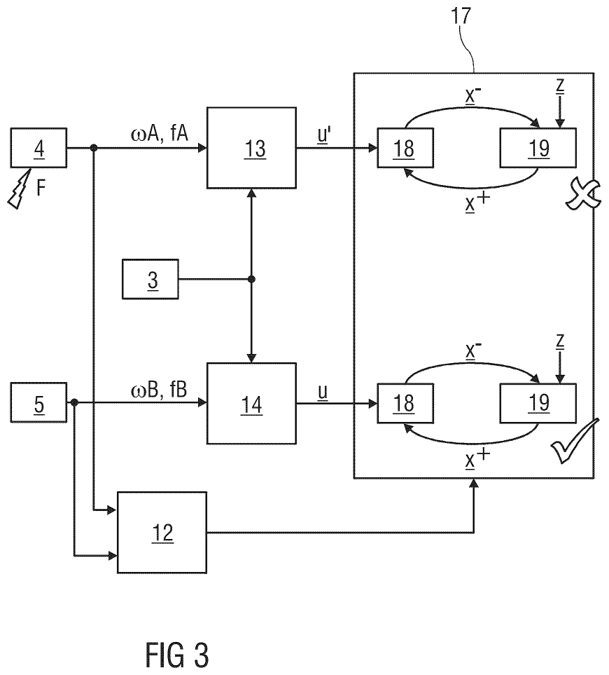

In comparison to the prior art in FIG. 2, the results of the calculations of the state of motion (correct pose of the vehicle u and incorrect pose of the vehicle u′) of the vehicle and the information from the monitoring unit 12 are supplied to the object tracking unit 17 according to the invention as shown in FIG. 3. There, the state of motion is used in a prediction block 18 for predicting the position x⁻ of the objects in the vehicle surroundings. The predicted positions x⁻ are then compared in a correction unit 19 for the object position with object measurements z from the environment sensor system and accordingly corrected (corrected position x⁺ of the objects in the vehicle surroundings). In the case of a fault F of an inertial measurement unit 4, 5, a large fault occurs between the predicted position x⁻ and measured or corrected position x⁺. This is then used in combination with the independent IMU fault detection in the monitoring unit 12 to recognize the IMU fault F, to localize it (assign it to the concerned IMU) and to isolate the IMU fault, if necessary, by switching to the redundant solution, i.e., the respective fault-free inertial measurement unit 4, 5. If neither of the inertial measurement units 4, 5 has a fault, then there is a good match between a predicted position x⁻ and a measured or corrected position x⁺.

The detection problem is solved by continuing to propagate the two redundant ego motion estimations into the object tracking unit 17. These are then available there as hypotheses of the ego motion of the vehicle.

The object tracking unit 17 usually receives data in relation to objects in the surroundings of the vehicle from different sensor sources (e.g., camera, radar, lidar and ultrasound). This data is then typically fused and tracked over time, in order to extract object information, to track the temporal motion of these objects and to predict their future motion. For example, dynamic objects, such as vehicles and pedestrians, can be monitored. The recognition of static objects, e.g., small obstacles on the road, is another example of tasks of the object tracking unit 17.

By fusing objects in the vehicle surroundings, the ego motion of the vehicle has to be compensated in order to calculate the correct position and speed of these objects. For this purpose, an exact and reliable motion estimation is used as input in the object tracking unit 17, from VMO 13 or 14. In the object tracking unit 17, the ego state of motion serves to predict the position of the surrounding objects between the observations via the environment sensor system. A faulty ego state of motion means that the position of these objects is incorrectly predicted. For example, this can mean that the static objects change their position from one observation time point to the next. All tracked static objects would be affected by this effect simultaneously. This leads to the fundamental idea of the invention: If movement of an object in the vehicle surroundings, which was previously classified as static (e.g., a wall), is suddenly predicted, then there is probably a fault in the motion calculation.

The solution according to the invention now consists of calculating two ego motion estimations in respective Kalman filters 13, 14 or VMO as hypotheses for the two redundant inertial measurement units 4 and 5. The sensor values of the inertial measurement units 4, 5 are supplied simultaneously to a monitoring unit 12. If the two inertial measurement units 4, 5 are operating correctly, then they deliver similar sensor signals with differences that are below the thresholds of the monitoring unit 12 and the ego states of motion, calculated therefrom, are also the same and consistent with the objects in the vehicle surroundings observed by the object tracking unit 17. If a fault F occurs in one of the IMU sensors 4, 5, this result is detected by the monitoring unit 12. On the other hand, the hypotheses for the vehicle's ego state of motion are now different and the fault-prone solution results in a mismatch between the predicted and measured position of objects. On the other hand, the fault-free state of motion calculated from the fault-free IMU will be consistent with the observed objects. By combining the two methods, both the faulty IMU 4, 5 as well as the sensor with the fault F can be clearly localized and the system can switch to the backup solution.

In an embodiment, the states of motion BZ A, BZ B, which are calculated from the two redundant inertial measurement units 4, 5, can be supplied to the object tracking unit 17 for further processing.

In an embodiment, the fault condition from the IMU monitoring unit 12, which has been determined by comparing corresponding IMU sensors of the two inertial measurement units 4, 5, can be supplied to the object tracking unit 17, so that only in the event of a fault F do the two hypotheses for the state of motion have to be checked.

In an embodiment, the ego motion of the vehicle 22 is described by pose of the vehicle

$$\underline{u} = [ \begin{matrix}Δ {q}_{eb}^{n} \\ Δ {p}_{b}^{n}\end{matrix} ] \qquad ( 1 )$$

wherein Δq_{eb}ⁿ is the orientation increment (angle increment) of the vehicle 22 relative to a local earth-fixed (tangential) coordinate system 20 with the axes xⁿ and yⁿ and Δp_{b}ⁿ is the position increment of the affected vehicle 22 in the earth-fixed coordinate system 20. If C(Δ_{eb}ⁿ) now denotes the rotation matrix, which can be calculated from the orientation increment, then the entire transformation (rotation and displacement) of an object from earth-fixed to vehicle-fixed coordinates can be described by the homogeneous matrix (homogeneous transformation from earth-fixed coordinates to vehicle-fixed coordinates) from [8, 10], which is well known from practical applications

$$H ( \underline{u} ) = [ \begin{matrix}{C}^{- 1} ( Δ {q}_{eb}^{n} ) & - {C}^{- 1} ( Δ {q}_{eb}^{n} ) Δ {p}_{b}^{n} \\ 0 & 1\end{matrix} ] \qquad ( 2 )$$

In an embodiment, predicted values for the position of objects in the vehicle surroundings can be calculated from the two states for the vehicle's ego motion and previous object positions. If Δpₒⁿ now denotes the position of an object in earth-fixed coordinates, its position Δpₒ^{b} in vehicle-fixed coordinates is given by the equation:

$$[ \begin{matrix}Δ {p}_{o}^{b} \\ 1\end{matrix} ] = H ( \underline{u} ) \cdot [ \begin{matrix}Δ {p}_{o}^{n} \\ 1\end{matrix} ] \qquad ( 3 )$$

Here, Δpₒ^{b} is the position of the object as can be measured by a vehicle-fixed environment sensor (camera, lidar, radar) relative to the vehicle 22.

In an embodiment, the object position

$$\underline{x} = [ \begin{matrix}Δ {p}_{o}^{n} \\ 1\end{matrix} ] \qquad ( 4 )$$

of the object in earth-fixed coordinates represents the state of the object for the object tracking and

$$\underline{z} = [ \begin{matrix}Δ {p}_{o}^{b} \\ 1\end{matrix} ] \qquad ( 5 )$$

is the measured variable (object position measurement using an environment sensor system) delivered by the environment sensor system which has to be fused in a Kalman filter 13, 14 in order to localize the object. For simplification, here it is assumed that the object has already been classified as stationary. In this case, x has to be constant and the fusion task in the Kalman filter 13, 14 consists of a correction (innovation) of the estimated object state \hat{x} (the estimated position of the object) with the aid of the measurement z. If zₖ now denotes a sequence of measurements of the object at discrete points in time k=0, 1, 2, . . . and uₖ are the associated vehicle poses and \hat{x}ₖ⁻ is the estimate of the object position before the correction (a-priori), then the correction to an improved (a-posteriori) position estimate \hat{x}ₖ⁺ takes place via the equation

$${\hat{\underline{x}}}_{k}^{+} = {\hat{\underline{x}}}_{k}^{-} + K \cdot ( {\underline{z}}_{k} - H ( {\underline{u}}_{k} ) {\hat{\underline{x}}}_{k}^{-} ) \qquad ( 6 )$$

wherein the difference between the measurement and the predicted measurement variable, determined from vehicle ego motion and a-priori position estimate, is referred to as an innovation vₖ [2, 3, 1]:

$${\underline{v}}_{k} = {\underline{z}}_{k} - H ( {\underline{u}}_{k} ) {\underline{x}}_{k}^{-} \qquad ( 7 )$$

According to Kalman filter theory, the static distribution of the innovation can be calculated by its covariance matrix

$${S}_{k} = H ( {\underline{u}}_{k} ) {P}_{k}^{-} {H}^{T} ( {\underline{u}}_{k} ) + {R}_{k} \qquad ( 8 )$$

wherein Pₖ⁻ is the covariance matrix of the a-priori state of estimation fault and Rₖ is the covariance matrix of the measurement fault. The latter contains basic statistical assumptions about the accuracy (fault distribution) of measurement faults and ego motion estimation. For each component vᵢₖ of the innovation vector vₖ, the following estimate then applies

$$\vert {v}_{ik} \vert < κ \sqrt{{s}_{iik}} , κ = 3 …4 \qquad ( 9 )$$

This means the difference of the measurement and predicted measurement should be smaller than a multiple of its standard deviation given by the diagonal element Suk of the covariance. (If κ=3, then 99.73% of the innovations should be in the range described by equation (9) on statistical average. With κ=4 it would be 99.994%). If this is not the case, there is either a fault in the measurement (outlier) or a fault in the prediction (e.g. due to incorrectly calculated ego motion). Now let uₖ^{A} and uₖ^{B} be two hypotheses for the ego motion, based on the respective inertial measurement units A and B, 4 and 5 and \hat{x}ₖ⁻ be the a-priori estimated position of an object in the vehicle surroundings, classified as static. If a fault F in IMU A, 4 and the resulting fault in uₖ^{A} results in the fact that for the elements of the assigned innovation

$$\vert {v}_{ik}^{A} \vert > κ \sqrt{{s}_{iik}} \qquad ( 10 )$$

applies, but the following applies for the elements of the innovation assigned to the hypothesis uₖ^{B}

$$\vert {v}_{ik}^{B} \vert < κ \sqrt{{s}_{iik}} \qquad ( 11 )$$

then the hypothesis A can be clearly detected as incorrect and there is a fault in the ego motion A. In this manner, a fault previously recognized by the IMU monitoring of the monitoring unit 12 can be clearly assigned to one of the two IMUs 4, 5.

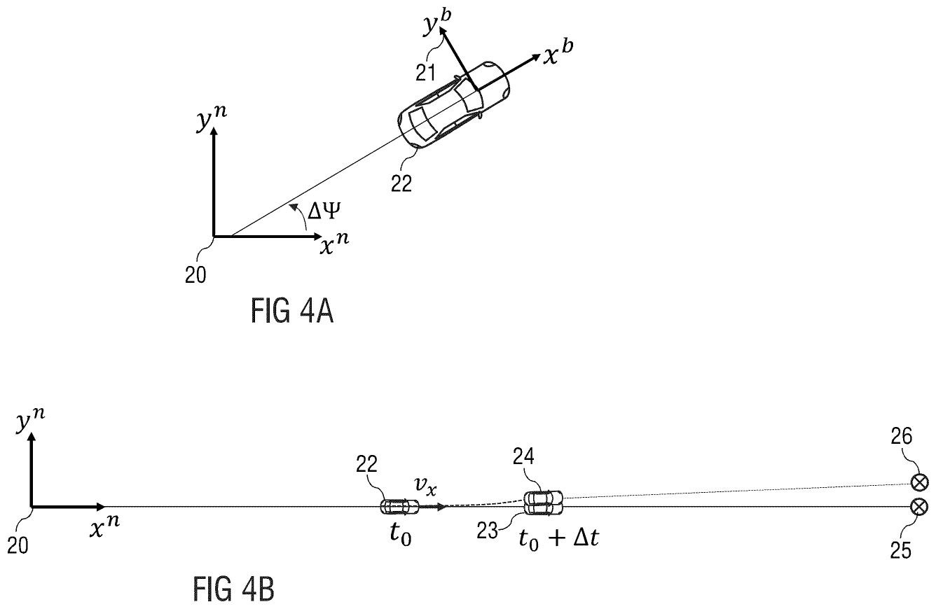

A simple example in the two-dimensional space is intended to illustrate this approach using FIG. 4. FIG. 4A shows the relationship between an earth-fixed coordinate system 20 and a vehicle-fixed coordinate system 21 for a vehicle 22 with the axes x^{b} and y^{b} in the two-dimensional space. The yaw angle Y describes the rotation between the two systems. The corresponding rotational matrix is

$$C ( Ψ ) = [ \begin{matrix}cos Ψ & - sin Ψ \\ sin Ψ & cos Ψ\end{matrix} ] \qquad ( 12 )$$

In the example shown in FIG. 4B, a vehicle 22 drives with a constant speed vₓ straight ahead to an object standing directly in front of the vehicle 22, at the object position 25, which is described by the vector

$$\underline{x} = [ \begin{matrix}{x}_{o} \\ 0 \\ 1\end{matrix} ] \qquad ( 13 )$$

At the time to corresponding to the discrete time k=0, the vehicle 22 has a yaw angle increment ΔΨ₀=0 and the position increment

$$Δ {p}_{b 0}^{n} = [ \begin{matrix}0 \\ 0\end{matrix} ] \qquad ( 14 )$$

The motion of the vehicle 22 is described by the following three equations:

$$Δ \dot{Ψ} = {ω}_{z} \qquad ( 15 )$$

$$Δ \dot{x} = {v}_{x} cos Δ Ψ - {v}_{y} sin Δ Ψ \qquad ( 16 )$$

$$Δ \dot{y} = {v}_{x} sin Δ Ψ + {v}_{y} cos Δ Ψ \qquad ( 17 )$$

The rotational speed w_{z} in this context is also referred to as yaw rate and is measured via the inertial measurement unit 4, 5. The speed vₓ is the body-fixed longitudinal speed of the vehicle 22, which can be calculated in the VMO 13, 14 by fusing the wheel revolution sensors with the IMU data. A common simplification of the calculation for the example consists of calculating the lateral speed of the vehicle 22 from the equation

$${v}_{y} \approx {l}_{r} {ω}_{z} \qquad ( 18 )$$

In this case, lᵣ is the distance of the coordinate origin of the vehicle-fixed coordinate system 21 from the rear axle of the vehicle 22. This is referred to as purely kinematic driving. If the vehicle 22 is travelling straight ahead, ω_{z}=0. It follows that ΔΨ=0 and an integration of the equations of motion up to the time t₁=t₀+Δt corresponding to discrete time k=1 results in a new pose 23 u₁ of the vehicle 22

$$Δ {Ψ}_{1} = 0 , Δ {p}_{b 1}^{n} = [ \begin{matrix}{v}_{x} Δ t \\ 0\end{matrix} ] \qquad ( 19 )$$

This results in the following for the measured position of the object in vehicle coordinates

$${\underline{z}}_{1} = H ( {\underline{u}}_{1} ) {\underline{x}}_{o} = [ \begin{matrix}1 & 0 & - {v}_{x} Δ t \\ 0 & 1 & 0 \\ 0 & 0 & 1\end{matrix} ] \cdot [ \begin{matrix}{x}_{o} \\ 0 \\ 1\end{matrix} ] = [ \begin{matrix}{x}_{o} = {v}_{x} Δ t \\ 0 \\ 1\end{matrix} ] \qquad ( 20 )$$

If a constant bias fault δω₂ now occurs in the yaw rate sensor of the IMU at time t₀, instead of the real yaw rate ω_{z}=0, the incorrect yaw rate

$${ω}_{z} = 0 + δ {ω}_{z} \qquad ( 21 )$$

is measured by the sensor. Integration of the equation (15) then leads at the time t₁ to the incorrect yaw angle

$$Δ {Ψ}_{1} = δ {ω}_{z} \cdot Δ t \qquad ( 22 )$$

This fault propagates into the position calculation and leads to an incorrectly calculated pose 24 of the vehicle 22. For demonstration purposes, we assume that the yaw angle fault is small and that the angle approximations

$$sin Δ Ψ \approx Δ Ψ , cos Δ Ψ \approx 1 \qquad ( 23 )$$

apply to trigonometric functions. With this approximation, the incorrect position caused by the yaw rate disturbance can be calculated analytically by integrating equations (16) and (17). This gives

$$Δ {p}_{b 1}^{n} = [ \begin{matrix}{v}_{x} Δ t - \frac{1}{2} {l}_{r} Δ {Ψ}_{1}^{2} \\ ( \frac{1}{2} {v}_{x} Δ t + {l}_{r} ) {ΔΨ}_{1}\end{matrix} ] \qquad ( 24 )$$

With the rotation matrix obtained from the small angle approximation

$$C ( Δ {Ψ}_{1} ) = [ \begin{matrix}1 & - Δ {Ψ}_{1} \\ Δ {Ψ}_{1} & 1\end{matrix} ] \qquad ( 25 )$$

the matrix H(u₁) can then be calculated.

$$H ( {\underline{u}}_{1} ) = [ \begin{matrix}1 & Δ {Ψ}_{1} & - ( 1 + \frac{1}{2} {ΔΨ}_{1} ) \cdot {v}_{x} Δ t - \frac{1}{2} {l}_{r} Δ {Ψ}_{1} \\ - Δ {Ψ}_{1} & 1 & ( \frac{1}{2} {v}_{x} Δ t - {l}_{r} ) {ΔΨ}_{1} - \frac{1}{2} {l}_{r} Δ {Ψ}_{1}^{3} \\ 0 & 0 & 1\end{matrix} ] \qquad ( 26 )$$

The final result for the prediction of the measurement from the vehicle's ego motion is

$${\hat{z}}_{1}^{-} H ( {\underline{u}}_{1} ) \cdot {\underline{x}}_{1}^{-} = [ \begin{matrix}{x}_{o} - ( 1 + \frac{1}{2} {ΔΨ}_{1}^{2} ) \cdot {v}_{x} Δ t - \frac{1}{2} {l}_{r} {ΔΨ}_{1}^{2} \\ ( \frac{1}{2} {v}_{x} Δ t - {l}_{r} - {x}_{o} ) \cdot {ΔΨ}_{1} - \frac{1}{2} {l}_{r} Δ {Ψ}_{1}^{3}\end{matrix} ] \qquad ( 27 )$$

This result can be illustrated best by a numerical example:

$${v}_{x} = 30 \frac{m}{s} \qquad ( 28 )$$

$${l}_{r} = 1.5 m \qquad ( 29 )$$

$$δ {ω}_{z} = 1 \frac{∘}{s} \qquad ( 30 )$$

$${x}_{o} = 80 m \qquad ( 31 )$$

$$Δ t = 0.3 s \qquad ( 32 )$$

For the case of the yaw rate without a fault F, the exact prediction of the measurement results in

$${\hat{z}}_{1}^{-} = [ \begin{matrix}71 m \\ 0 \\ 1\end{matrix} ] \qquad ( 33 )$$

For the case of the yaw rate with fault F, the following is obtained

$${\hat{z}}_{1}^{-} = [ \begin{matrix}70.9 \; 999 m \\ - 0.4 \; 032 m \\ 1\end{matrix} ] \qquad ( 34 )$$

This means that with the incorrect ego motion, the position of the object 25 in vehicle coordinates is predicted to be shifted by more than 0.4 m to the right in relation to the y-components, while the measured object position 26 is still exactly in front of the vehicle 22 in the event of fault F. If the related standard deviation is √s̅ᵢ̅ₜ̅ₖ̅=0.1 m for example, then the corresponding hypothesis can be rejected as false with κ=3.

In one embodiment, the two hypotheses for the predicted positions of the objects can be compared with the object positions 25, 26 measured via the environment sensor system. If the deviation of the measured object position 25, 26 from the predicted object position 25, 26 exceeds a threshold value for one of the hypotheses but not for the other hypothesis, then a fault in the relevant inertial measurement unit 4, 5 can be inferred.

In one embodiment, the results of the monitoring of the two IMU sensors 4, 5 can be included in the fault detection of the object tracking unit 17. In this case, a fault F is then only recognized when the deviation of the predicted object position 25, 26 exceeds a threshold for one of the hypotheses but not for the other, and simultaneously a fault was detected via the sensor comparison of the IMU fault detection unit 16.

In one embodiment, only one object recognized as stationary or multiple objects recognized as stationary are included in the fault detection, and a fault F can be recognized for the hypothesis in the case of which the predicted object position 25, 26 changes considerably, whereas it remains locally constant for the other hypothesis.

The invention enables a fault-tolerant determination of the motion variables of a vehicle 22 in the event of an IMU fault F (fail operational) with simple redundancy. No special requirements are placed on geometric arrangement and sensor quality. Instead, the invention can also be applied to cost-effective, heterogeneous IMU hardware that is already present in the vehicle 22 in some cases.

The method according to the invention enables protection of the signals of the master inertial measurement unit 4 against sensor faults as a measure to ensure the functional safety (fail-operational) of the estimation of the ego motion of a vehicle, taking into consideration increased safety requirements for autonomous driving.

The focus here is on the use of heterogeneous (non-uniform) inertial measurement units (IMU) 4, 5 installed in particular at different points in the vehicle 22.

With the solution according to the invention, fault tolerance (fail-operational) is achieved in the calculation of vehicle motion variables. In this case, systems and methods for object detection and fusion already present in driver assistance systems and autonomous vehicles are used.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### BIBLIOGRAPHY

[1] Berman, Z.: Outliers Rejection in Kalman Filtering-Some New Observations. In: IEEE/ION Position, Location and Navigation Symposium-PLANS 2014, p. 1008-1013 9
[2] Grewal, M. S.; Adrews, A. P.: Kalman Filtering. New York: John Wiley, 2001 9
[3] Groves, P. D.: Principles of GNSS, Inertial and Multisensor integrated Navigation systems. Artech House, 2013 9 [4] Kalkkuhl, J.; Bergmann, M.; Engelhardt, T.; Bleimund, F.: DE 10 2021 004 103 A1:
Verfahren und Anordnung zur Überwachung und Detektion von Sensorfehlern in Inertial-Mess-Systemen [Method and arrangement for monitoring and detecting sensor faults in inertial measurement systems] 3, 17
[5] Klier, W.; Reim, A.; Stapel, D.: Robust Estimation of Vehicle Sideslip Angle—An Approach w/o Vehicle and Tire Models. In: SAE Technical Paper Series (2008), No. 2008-01-0582 1
[6] Mercep, L.; Pollach, M.: U.S. Pat. No. 10,553,044B2: Self-diagnosis of faults with a secondary system in an autonomous driving system. 4
[7] Mercep, L.; Pollach, M.: U.S. Pat. No. 11,145,146B2: Self-Diagnosis of Faults in an Autonomous Driving System 4
[8] Rabe, C.: Detection of Moving Objects by Spatio-Temporal Motion Analysis, Christian-Albrecht University of Kiel, Diss., 2011 7
[9] Wendel, J.: Integrierte Navigationssysteme [Integrated navigation systems]. Oldenbourg, 2007
[10] Woo, A.; Fidan, B.; Melek, W. W.: Localization for Autonomous Driving. In: Zekavat, S. A. (Ed.); Buehrer, R. M. (Ed.): Handbook of Position Localization. IEEE Press Wiley, Chapter 29 7

1-8. (canceled)

9. A method comprising:
generating, by a master inertial measurement unit of a vehicle, first measurement signals, wherein the first inertial measurement unit includes a first accelerometer and gyroscopic sensors;
generating, by a slave inertial measurement unit of the vehicle, second measurement signals, wherein the second inertial measurement unit includes a second accelerometer and gyroscopic sensors;
estimating, using the first and second measurements, fault model parameters of the slave inertial measurement unit, wherein the first measurement signals are used as reference values in the estimation of fault model parameters of the slave inertial measurement unit relative to the master inertial measurement unit;
determining, by comparing the first and second measurement signals, that there is a fault in one of the master and slave inertial measurement units;
determining, using the first measurement signals by a downstream Kalman filter in an object tracking unit of the vehicle, a first motion estimation of an object in a surroundings of the vehicle;
determining, using the second measurement signals by the downstream Kalman filter, a second motion estimation of the object in the surroundings of the vehicle;
determining that one of the first and second motion estimations of the object leads to an incorrect prediction of a position of the object in the surroundings of the vehicle; and
identifying the master or slave inertial measurement unit as faulty based on the one of the first and second motion estimations that leads to the incorrect prediction of the position of the object in the surroundings of the vehicle.

10. The method of claim 9, further comprising:
receiving, by a monitoring unit, the first and second measurement signals;
determining, by the monitoring unit based on the received first and second measurement signals, a fault condition; and
transmitting, by the monitoring unit to the object tracking unit, the determined fault condition so that, when it is determined that one of the master and slave inertial measurement units is faulty, multiple hypotheses for a state of motion are tested, wherein, when neither of the master and slave inertial measurement units is faulty, only one state of motion is used by the vehicle.

11. The method of claim 9, wherein an ego motion of the vehicle is described by a pose of the vehicle and is transmitted to the object tracking unit.

12. The method of claim 11, further comprising:
predicting, in vehicle-fixed coordinates in the object tracking unit using the pose of the vehicle and a previously calculated object position of the object, a new position of the object; or
predicting, in the vehicle-fixed coordinates in the object tracking unit using the pose of the vehicle and previously calculated object positions of a plurality of objects, new positions of the objects, wherein the object is one of the plurality of objects.

13. The method of claim 9, further comprising:
comparing a position of the object measured by an environment sensor system of the vehicle with a position of the object predicted by ego motion hypotheses of the vehicle determined using the Kalman filter, wherein the ego motion hypotheses is determined to be incorrect when a deviation between the predicted and measured object position exceeds a threshold.

14. The method of claim 9, further comprising:
switching from one of the master and slave inertial measurement units to the other one of the master and slave inertial measurement units when the master or slave inertial measurement unit is identified as faulty.

15. The method of claim 10, wherein the identification that the master or slave inertial measurement unit as faulty is based on monitoring the master and slave inertial measurement units, wherein the master or slave inertial measurement unit is only recognized as faulty if a deviation of a predicted position of the object (25, 26) exceeds a threshold for one of the hypotheses but does not exceed a threshold for another one of the hypotheses, and simultaneously one of the master and slave inertial measurement units is identified as faulty based on the comparison of the first and second measurement signals.

16. The method of claim 10, wherein the object is a single object recoginzed as stationary or the object is a plurality of objects recognized as stationary, wherein the fault of one of the master and slave inertial measurement units is determined when a predicted position for one of the hypothesis changes considerably compared to another one of the hypothesis and the other one of the hypothesis remains locally constant.
